(19) United States
(12) Patent Application Publication
(10) Pub. No.: US 2020/0380247 A1
(43) Pub. Date: Dec. 3, 2020

(54) METHOD FOR EVALUATING AND SELECTING SAMPLES OF FACIAL IMAGES FOR FACIAL RECOGNITION FROM VIDEO SEQUENCES

(71) Applicants: FACULDADES CATÓLICAS, ASSOCIAÇÄO SEM FINS LUCRATIVOS, MANTENEDORA DA PONTIFÍCIA UNIVERSIDADE CATOLI, Gávea, Rio de Janeiro (BR); M.I. MONTREAL INFORMÁTICA LTDA, Centro, Rio de Janeiro (BR)

(72) Inventors: Antonio Carlos Censi, Rio de Janeiro (BR); José Luiz Buonomo Pinho, Niterói (BR); Raul Queiroz Feitosa, Rio de Janeiro (BR)

(73) Assignees: FACULDADES CATÓLICAS, ASSOCIAÇÄO SEM FINS LUCRATIVOS, MANTENEDORA DA PONTIFÍCIA UNIVERSIDADE; CATÓLICA DO RIO DE JANEIRO - PUC-RIO, Gávea, Rio de Janeiro (BR); M.I. MONTREAL INFORMÁTICA LTDA, Centro, Rio de Janeiro (BR)

(21) Appl. No.: 16/471,697

(22) PCT Filed: Dec. 20, 2017
(86) PCT No.: PCT/BR2017/050394

§ 371 Date: Sep. 30, 2019

(30) Foreign Application Priority Data
Dec. 23, 2016 (BR) BR 102016030449-0

(51) Int. Cl. G06K 9/00

(52) U.S. Cl. CPC G06K 9/00288; G06K 9/00744; G06K 9/00275

(57) ABSTRACT

A method to select facial images taken from video to be submitted to a recognition process. The images are managed based on rules guiding the decisions about the images that are considered or discarded for recognition, thus obtaining a reduction in the associated computational load. The rules dictate that an image taken from each new frame of the processed video will only be selected for recognition if it is significantly different from the images taken from the frames previously processed and admitted for recognition. The method manages the database that contains the selected images as a least recently used (LRU) queue. Each proof image is moved to the end of the LRU queue each time it is viewed as similar to the one being considered for admission. When the queue is full, if it is decided to add a new image, the image ahead in the queue is selected to be replaced.

### FIELD OF THE INVENTION

The present invention is concerned with a method aimed to find for each application the appropriate tradeoff between recognition rates and computational performance of facial recognition systems based on video sequences. Specifically, this invention proposes a method for reducing the number of video frames to be subjected to the recognition procedure with little impact on recognition rates. This method consists of criteria to submit each video frame being processed in order to decide whether or not said frame should be considered for subsequent processing. Such criteria can be tuned in order to achieve for each application the best tradeoff between computational load and recognition rates.

### BACKGROUND OF THE INVENTION

Biometrics encompasses people-recognition techniques based on physical and/or behavioral characteristics. Among the widely used physical features are fingerprint, facial image, iris structure, and hand geometry; among the most commonly used behavioral characteristics are signature and voice.

Thus, a biometric system lends itself to recognizing an individual based on particular physical or behavioral characteristics. Basically, recognition is carried out by comparing one or more biometric characteristics measured by specific sensors, with the biometric characteristics of individuals whose identity is known a priori and are stored in some database.

The quality of the sensors for obtaining the biometric data and the method of comparison used are fundamental for the effectiveness and efficiency of the recognition. The present invention proposes a method enabling a tradeoff between effectiveness and efficiency that best suits the demands of each application.

Biometric recognition systems can operate in two main modes: verification and identification.

In verification mode, a person claims an identity, and the biometric system determines based on his/her biometric characteristics if the claimed identity is true or false. The decision is made by comparing biometric measures of the person making the claim with the biometric measures corresponding to the claimed identity which are stored in a database, often called a gallery.

In identification mode, no identity is claimed, and the biometric system must determine the identity based on his/her biometric characteristics. Typically, the identification system somehow compares the biometric characteristics of the person to be identified with the biometric characteristics of people whose identities are known a priori and which are enrolled in a gallery (database), as illustrated in FIG. 1.

Although the benefits of the present invention become more apparent when operating in the identification mode, as will be seen later, the invention may be applied in both the verification mode and the identification mode. The text refers in some parts to the identification, without excluding the application of the proposal to the verification mode.

In case of facial recognition, in both operation modes, verification and identification, the decision is made based on a measure of dissimilarity between the facial images captured by some camera and facial images enrolled in the gallery.

Generally, a recognition system operates internally with descriptors of facial images rather than facial images per se. Without loss of generality, for the sake of simplicity the subsequent text uses the term “facial image” to denote the facial image itself or its descriptor.

The set of facial images from the subject whose identity is to be determined or verified is stored in a data structure, called proof or proof set, as illustrated in FIG. 2. Similar to a gallery record, a proof may comprise several facial image samples of the subject to be identified.

Traditional facial identification methods are based on still images taken under controlled conditions and with the cooperation of the person to be identified. On the contrary, in facial identification applications from video sequences, typically the images are taken under uncontrolled conditions, without the cooperation of individuals who do not generally know and do not even want to be identified.

On the other hand, video applications have an advantage over applications based on still images. Videos are comparatively more abundant sources of facial images. With a conventional video camera operating at a few tens of frames per second, hundreds or thousands of facial image samples of the same person can be taken in a few seconds or minutes, which rarely occurs in applications based on still images.

As video frames are being processed, more facial image samples can be added to the proof, which allows a continuous improvement of the identity estimation. This benefit comes, however, at a cost. In fact, the computational complexity of identification increases with the number of people registered in the gallery since it involves calculating a dissimilarity metric for all gallery records, which can make up to tens or hundreds of millions of records in some applications. Any proof change resulting from the inclusion of a new facial image implies recalculating dissimilarity metrics in order to reflect the new proof configuration. Depending on the number of records in the gallery, reworking this calculation for each processed video frame may lead to unacceptable response times for some applications.

Conventional facial recognition methods from video sequences generally involve four main procedures: detection, tracking, frame selection and recognition.

The detection procedure scans each video frame looking for regions whose intensity pattern corresponds to a facial image.

Once a facial image has been detected in a video frame by the detection procedure, the tracking procedure tracks the subject's face image along the subsequent frames. Typically, tracking is able to track multiple facial images simultaneously. However, without loss of generality, to simplify the following exposure the subsequent text always refers to a face. It should be noted, however, that the proposed method works independently on the number of facial images being simultaneously tracked.

The frame selection procedure is responsible for verifying whether a region being tracked meets a given set of conditions to be incorporated into the proof. The proof consists, therefore, of a set of facial images taken along the tracking and approved by the frame selection criteria.

The recognition procedure calculates dissimilarity between the proof and the gallery records. These dissimilarity values may represent, among other metrics, probabilities, likelihoods, memberships or merely scores calculated by a variety of methods. The identification is based on sorting of the individuals registered in the gallery according to the values of such metrics.

The present invention proposes criteria to be imposed on each new facial image sample in order for it be added to the proof. They are criteria based on dissimilarity between each new sample considered for inclusion in the proof and the samples already making up the proof. The central idea underlying this invention is that only a new facial image sample is included in the proof if such inclusion implies a significant change in the dissimilarity values computed from the images already making up the proof. It is assumed that such a change only occurs if the new image differs substantially from all images already in the proof.

### SUMMARY OF THE INVENTION

Facial recognition systems from video sequences usually bring together facial image samples of the person to be identified in a data structure, which is being called proof herein. The method decides whether or not a new image should be included in the proof.

The present invention provides a criterion to which each new video frame must be subjected, a criterion which determines whether or not the facial image contained in said frame is to be considered for the purposes of recognition of the person being imaged. Such a criterion consists essentially of verifying whether such an image is significantly different from all the same person's images in the proof taken in video frames already processed.

If the memory space allocated to the proof is completely filled by images taken from previously processed frames, it will be necessary to choose one image in the proof to be replaced by the new image to be admitted. The method proposed herein is based on the organization of the proof as a least recently used (LRU) queue, Each proof image is moved to the end of the LRU queue each time it is considered similar to the one being considered for admission.

The proposed method selects the proof image to be deleted which is ahead in the LRU queue. The invention thus aims to reduce the computational load associated with the recognition with little impairment to the recognition rates. The proposed criteria can operate combined with other criteria, such as this taking into account the quality of the image. The invention is not specific to a particular recognition strategy and may be adapted to recognition systems based on several recognition algorithms.

The proposed method is based on a comparison of the facial image contained in the video frame that is being processed with the facial images already gathered when the previous video frames were processed, and the new image will only be considered for recognition if it differs significantly.

### BRIEF DESCRIPTION OF THE DRAWINGS

The present invention may be more readily understood with the aid of the accompanying illustrative figures, which in a schematic and non-limiting way of its scope represent:

FIG. 1—Schematic view of the database containing facial image records

FIG. 2—Schematic view of the data structure, called proof, which contains the set of facial images of the individual whose identity is to be determined.

FIG. 3—Representation of the texture of a facial image according to the LBP—Local Binary Pattern algorithm

FIG. 4—Examples of images and the corresponding LBP representations.

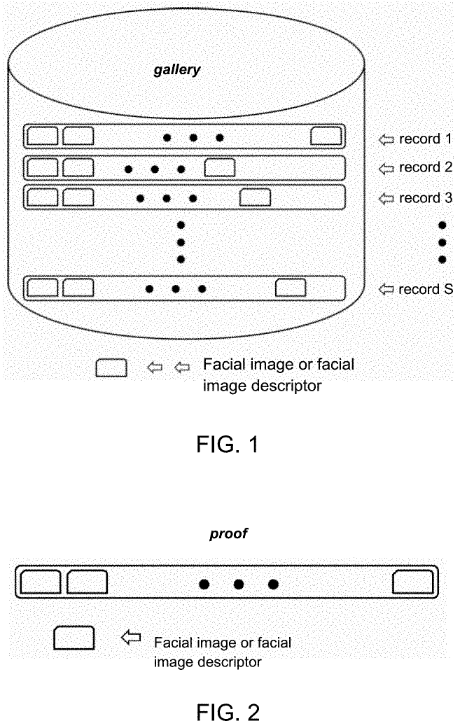

### DETAILED DESCRIPTION OF THE INVENTION

The present invention relates to the management of the set of facial images composing the proof in a video-based facial recognition system. It is proposed to adopt two criteria which the facial images taken from the video for admission or exclusion of the proof set is be submitted.

The first criterion concerns the admission of new facial images, while the second criterion refers to the selection of one of the proof images to be excluded when a new sample is to be admitted and the proof has all its records contain images taken from video previously processed frames.

With respect to the first criterion, the objective is to reduce the number of times the proof is updated incurring the least prejudice to the accuracy of the identification. The invention proposes a condition to be satisfied by a new image so that it is added to the proof set.

This condition may be applied alone or combined with other conditions such as those related to image quality and the limit amount of frames processed per second. It is proposed that the inclusion of a new image to the proof is conditioned to its potential to change the current values of dissimilarity calculated based on the current proof content.

In many recognition strategies the addition of an image sample highly correlated with an existing sample in the proof will not bring significant benefit in terms of accuracy. Thus, in order to be incorporated to the proof a new facial image should differ significantly from all images included in the proof. This condition aims to reduce the number of proof updates and consequently the number of times the recognition procedure is executed, thus improving the system response time.

The second criterion concerns situations which may occur when a new image is to be admitted to the proof. Since the memory space allocated to the proof is necessarily limited and new images are added to the proof as the video is being processed, this space eventually runs out. The present invention proposes an exclusion criterion of one of the images from the proof, to make room to the new image to be admitted to the proof. The proposed criterion aims to minimize the damage this exclusion may bring to the accuracy of the recognition. The criterion is based on the recent history of dissimilarity values measured by applying the admission criterion mentioned above which defines when a new image should or should not be admitted to the proof.

Both criteria are formally presented below. For the sake of clarity, it will be assumed in the following description that the system operates in the identification mode. It is worth remembering that the proposed method also applies to systems that operate on facial images directly, as well as on facial image descriptors. Thus, with no harm to the understanding and generality, the word facial image or simply image in this specification should be interpreted as referring generally to a facial image or to the descriptor of this image, calculated according to any algorithm.

Let G(s) be the registration containing n(s) facial images of s^{th} subject enrolled in the gallery which comprises a total of S records. Formally,

G(s)={g(s)₁, g(s)₂, . . . , g(s)ₙ₍ₛ₎}, to s=1, . . . S (1)

The proof is represented by the set P=({p₁, p₂, . . .} which may contain up to N facial images belonging to the imaged subject in the video whose identity is to be determined.

Let R[P, G(s)] be the function expressing the dissimilarity between two image sets, in particular, between the set P of images composing the proof and the sample set G(s) related to the s^{th} person entry in the gallery. It is assumed that the recognition is based on the dissimilarity values R[P,G(s)] between the proof and each gallery entry. Whenever a new facial image r is added to the proof P the recognition procedure is performed again to compute R[P ∪r, G(s)], in the case of the identification mode, to s=1, . . . , S, and thus update the dissimilarity value(s).

It should be mentioned again that the hypothesis underlying the admission strategy is motivated by the empirical observation that for some recognition algorithms the inclusion of a sample r in P does not cause significant change in any of the S dissimilarity values if it is very similar to some sample in P. In other words, for a function D(p, r) expressing the dissimilarity between two image descriptors p and r, in order for the inclusion of r in p to cause a significant change of the dissimilarity, the following relation must hold

maxₛ₌₁. . . S|R[P ∪r, G(s)]−R[P, G(s)]|≤min_{p∈p}D(p, r) (2)

The above relationship provides an upper limit for the change in dissimilarity values, if r is included in the set P. Thus, if ΔRₘᵢₙ represents the minimum significant change in dissimilarity values, the inclusion of r in P and the subsequent computational effort to update dissimilarity value(s) will only be worthwhile if the following condition holds

min_{p∈P}D(p, r)≥ΔRₘᵢₙ (3).

It should be noted that, in the identification mode, the computational complexity associated with the verification of condition (3) increases with the number of images in the proof, whereas the complexity of updating all similarity measures increases with the total images of the gallery. As already pointed out in previous sections, this difference can reach several orders of magnitude in some applications.

As regards the condition expressed by relation (3), two aspects need to be addressed. The first one concerns the choice of the value of ΔRₘᵢₙ. It should be kept in mind that an increase of ΔRₘᵢₙ.implies reducing the number of times the recognition procedure will be executed and hence the computational load. A possible side effect is the reduction of identification accuracy, since a larger number of facial images taken from the video will be disregarded.

The appropriate ΔRₘᵢₙ value will depend on the characteristics of the video and the requirements of the application, in addition, of course, to the adopted dissimilarity functions D(·) and R(·). Adaptive strategies to the adjustment of may also be considered to take into account differences in dissimilarity of the gallery records relative to the proof of each video frame processed.

Again, the main benefit of imposing such a condition for admission of new image samples to the proof set is to reduce the computational load of video recognition systems. The side effect to be weighed is the potential impact in the identification rates due to the non-admission of images to the proof.

The second aspect relative to the first criterion expressed by relation (3) concerns the functions of dissimilarity R(·) and D(·). The choice of these functions is usually dictated by the recognition algorithm on which the system is based. The section on preferred embodiment provides an example.

This invention further proposes a criterion to choose one image in the proof set to be replaced by a new image is to be admitted and all proof entries are occupied. As in the previous case, the criterion proposed herein aims to minimize the number of times the recognition procedure will be carried out after the exclusion. In other words, the choice of the image to be deleted must be made in such a way as to minimize the number of executions of the recognition procedure when processing the next video frames. Clearly it is impossible to determine which this image is for sure since the video frames which will still be processed in the future are unknown. The method proposed herein meets the objective in terms only probabilistic. It is based on a heuristic based on empirical observations. The criterion proposed in the present invention is inspired by the algorithm known as Least Recently Used (LRU) and widely used for virtual memory management.

The logic supporting this proposal is as follows. Adjacent video frames tend to be similar. Thus, when an image r extracted from the video is not admitted to the proof by virtue of the abovementioned admission criterion due to its similarity with an proof image p, it is likely that p, for the same reason, prevents admission of samples taken from the next subsequent frames. Similarly, it is assumed that proof images that did not prevent the admission of new images in the proof set along many consecutive frames have little probability of doing so in the upcoming frames.

Based on this hypothesis, it is proposed that the proof images are organized as an LRU (least recently used) queue. Images positioned closer to the end of the LRU queue are those that most recently prevented admission of new images to the proof due to the admissibility criterion. According to the admission strategy previously proposed, a new image r will not be admitted o the proof if it does not satisfy the condition expressed in the relation (3). In this case, the proof image p* most similar to r, i.e., p*=min_{p∈p} D(p, r) should be moved to the end of the LRU queue, while the images positioned after p* in the LRU queue are moved one position forward in the queue.

If, on the other hand, r satisfies the condition (3), it must be admitted to the proof set. Two situations should be considered in such case. Firstly, if there are free records in the proof, all proof images move one position forward, and r occupy the last position in the LRU queue. If, on the other hand, all proof positions are occupied, the image most ahead in the LRU queue is deleted, the other proof images move one position forward, and r occupies the last position in the LRU queue.

For illustration purposes only, the methods proposed for both admission and exclusion are formally described by the following pseudocode, stating forthwith variants incorporating the above methods are not excluded from the scope of the present invention.

Method of Evaluation and Selection of Facial Images

% P={p₁,p₂, . . . } is the proof set;

% P represents the number of valid samples in P;

% N is the maximum number of samples which may be accommodated in P;

% p₁ takes the first position in the LRU queue, while p#p takes the last one;

% r is the sample of which admission in the proff set is to be approved or rejected;

% ΔRₘᵢₙ is the threshold for admission of a new sample to the proof;

% i, j e aux are auxiliary variables.

if min_{p∈p}D(p, r)≤ΔRₘᵢₙ % admission approved

if #P≤N % if proof set is not full

P←P ∪ r, whereby p#ₚ=r % includes new sample in the proof

else % if proof set is full

for j=argminᵢ D(pᵢ, r)→N % updates LRU queue

pⱼ₋₁←pⱼ % moves samples ahead in the LRU queue

end for

p_{N}←r % new sample takes the end of the LRU queue

end if

else

aux←p_{min(D(p#r)} % separates most similar proof element to the new sample

for j=argminᵢ D(pᵢ, r)→#P

pⱼ₋₁←pⱼ % moves samples ahead in the LRU queue

end for

p#p←aux % most similar element to the new sample takes the end of the LRU queue

end if

### Preferred Embodiment

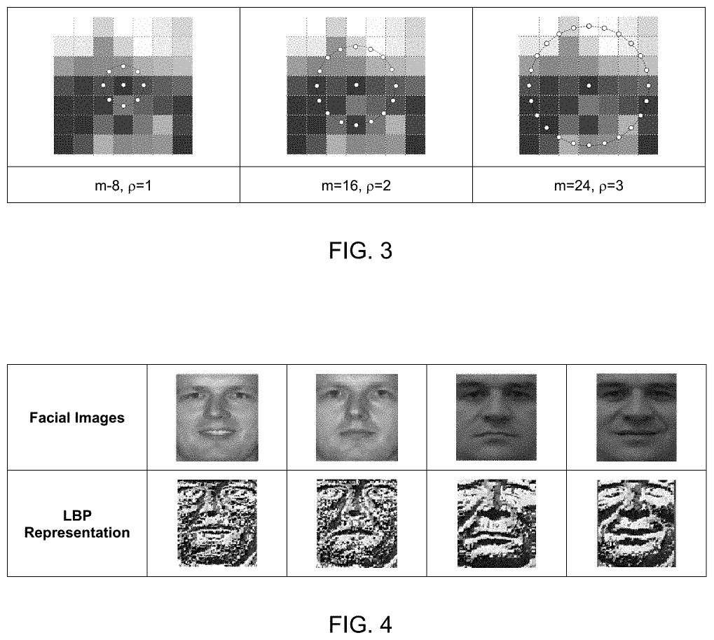

This preferred embodiment is based on a known texture coding method that relies on Local Binary Patterns (LBP), proposed by T. Ahonen, A. Hadid and M. Pietikäinen, The LBP representation is calculated by assigning to each pixel x located in the (x, y) coordinates a binary code. Such code is related to the signals of the intensity differences between said pixel in neighbors equally spaced along a circle of radius p, as shown in FIG. 3. The binary values “0” and “1” are assigned respectively to the negative and positive difference between said pixel and their m neighbors evenly spaced over a circle or radius p, as illustrated in FIG. 3. Bilinear interpolation is adopted whenever the coordinate of a neighbor does not lie in the center of a pixel. The LBP code results from the concatenation of m 0's and 1's in an arbitrary but fixed order. FIG. 4 shows the LBP representations for four examples of facial images, the intensities being related to the LBP code associated with each pixel.

Recognition based on the LBP codes works as follows. It is assumed that all analyzed facial images are well framed, that is, they have constant interocular distance, with the eye centers positioned in fixed coordinates of the image.

The matrix I containing the LBP representation of a facial image is divided into B disjoined blocks of equal size numbered 1 to B, as shown in FIG. 4. The histogram ^{b}H of the LBP codes contained in the b^{th} block is calculated for b=1,2, . . . , B and multiplied by a specific weight w_{b} of each block. The descriptor of the facial image is given by the vector p resulting from the concatenation of the weighted histograms w_{b} ^{b}H.

The dissimilarity function between the two-image representation is given by a distance or metric function D(·) which has the following properties where p, r and g represent facial image descriptors in this context:

i. (p, g)≥0

ii. D (p,g)=0, if and only if p=g (4)

iii. D (p,g)=D (g,p)

iv. D (p,g)≤D (p,r)+D (r,g)

The dissimilarity function between sets of image descriptors, for example, between the proof P and the s^{th} gallery record G(s) is defined as:

$$R [ P , G ( s ) ] = {min}_{p ∈ P , g ∈ G ( s )} [ D ( p , g ) ] . \qquad ( 5 )$$

It is shown below that the dissimilarity function defined in (5) satisfies relations (2) and (3) for any metric having the properties (4). From property iv) of (4) and from equation (5) follows that

R[P, G(s)]≤min_{p∈P,g∈G(s)}[D(p, r)+D(r, g)] (6)

to any sample r and, therefore,

R[P, G(s)]≤min_{p∈P}D(p, r)+min_{g∈G(s)} D(r, g) (7),

Since the relation (7) is valid for any r, it can be rewritten as:

R[P, G(s)]≤min_{p∈P}D(p, r)+min_{p∈P∪r,g∈G(s)}D(p, g) (8)

that yields

R[P, G(s)]−R[P ∪ r, G(s)]≤min_{p∈P}D(p, r)=R[P, (r)] (9)

According to relation (9), the change in the dissimilarity value of any gallery record due to adding the image r to the proof is limited superiorly by the dissimilarity of this sample in relation to the proof. Since the previous relation is valid for all gallery records

max_{s=1. . . . . S}(R[P, G(s)]−R[P ∪ r, G(s)])≥R[P, (r)] (10)

Clearly, from relations (9) and (10) it follows the dissimilarity function defined in (5) satisfies the conditions expressed in inequalities (2) and (3). Subsequently, the relation (3) provides a consistent condition for a sample to be admitted to the proof, as well as for the realization of the exclusion algorithm.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A method for the selection and management of facial images composing the proof in computational systems for facial recognition from video sequences, comprising:
measuring the dissimilarity of a facial image or its descriptor detected in the video frame being processed relative to each of the facial images or their descriptors contained in the proof set through a function having the properties of a metric;
admitting said facial image or its descriptor in the proof set only if said dissimilarity values related to all images of the proof set exceed a manually or automatically adjustable threshold; and
logically organizing the facial image or its descriptors that make up the proof set according to a least recently used queue.

16. The method according to claim 15, wherein the condition involving said dissimilarity measurement and subsequent comparison of the measured value with said threshold is a necessary condition for the admission of a facial image to the proof set.

17. The method according to claim 15, wherein the metric used to measure the dissimilarity between a facial image or its descriptor captured from a video frame and facial images or its descriptors making up the proof set is the same metric used in the recognition step to measure dissimilarity between a proof image and a gallery image.

18. The method according to claim 15, further comprising moving a facial image or its constant proof descriptor to the end of the LRU queue, when all of the following conditions are met:
a facial image is detected in the video frame being processed;
if the recognition system imposes additional conditions for admission to the proof set of a facial image or its descriptor, said additional conditions are met by said detected facial image or its descriptor;
said dissimilarity between said proof image or its descriptor and said detected facial image or its descriptor in the video frame being processed is less than said manually or automatically set threshold; and
said proof image or its descriptor is, among all the proof images or its descriptors, less dissimilar from said detected facial image or its descriptor in the video frame being processed.

19. The method according to claim 15, further comprising adopting the LRU strategy to select one of the proof images or its descriptors to be excluded, when the proof set is fully occupied and a new facial image or its descriptor qualifies for admission in the proof set.

20. The method according to claim 18, further comprising adopting the LRU strategy to logically reorder the images or its descriptors that remain in the proof when a new image or its descriptor is admitted in the proof set.

21. The method according to claim 19, further comprising adopting the LRU strategy to define the logical position in the proof set of a facial image or its newly admitted descriptor in the proof set.
